(19) United States
(12) Patent Application Publication
(10) Pub. No.: US 2025/0125593 A1
(43) Pub. Date: Apr. 17, 2025

(54) ELECTRICAL SWITCHGEAR WITH IMPROVED COOLING

(71) Applicant: Eaton Intelligent Power Limited, Dublin 4 (IE)

(72) Inventors: Shashank MISHRA, Pune (IN); Vinod Kumar PARMAR, Maharashtra (IN); Akshay BANKAR, Overijssel (NL); Paul GEUSENDAM, Overijssel (NL); Dinant Johan HEILERSIG, Overijssel (NL); Bhavesh GHAG, Gujarat (IN)

(21) Appl. No.: 18/688,569

(22) PCT Filed: Sep. 1, 2022
(86) PCT No.: PCT/EP2022/025408

§ 371 Date: Mar. 1, 2024

(30) Foreign Application Priority Data
Sep. 7, 2021 (IN) 202111040505
Oct. 27, 2021 (GB) 2115416.6

(51) Int. Cl. H02B 1/56; H01H 9/52; H02B 1/28; H02B 13/02

(52) U.S. Cl. CPC H02B 1/56; H01H 9/52; H02B 1/28; H02B 13/02; H01H 2009/526

(57) ABSTRACT

A switchgear is disclosed, which comprises a switchgear housing, a number of busbars and a number of disconnectors with-in the switchgear housing, wherein the disconnectors are arranged in the course of the busbars. Moreover, the switchgear comprises a dis-connector housing, which is arranged within the switchgear housing and encompasses at least the disconnectors. The disconnector housing has at least one bottom opening and at least one top opening allowing an air flow from the at least one bottom opening to the at least one top opening via said disconnectors.

### TECHNICAL FIELD

The invention relates to a switchgear, which comprises a switchgear housing, a number of busbars within the switchgear housing and a number of disconnectors within the switchgear housing, wherein the disconnectors are arranged in the course of the busbars.

### BACKGROUND ART

Generally, a switchgear of the above kind is known in prior art for distributing electricity and for switching electric circuits on and off. Due to the ever increasing component density, cooling of the components of the switchgear more and more becomes critical. This is particularly true in cases where the switchgears are air-tight and/or water-tight what limits or even inhibits an external air flow for cooling said components.

### DISCLOSURE OF INVENTION

Accordingly, an object of the invention is the provision of an improved switchgear. In particular, cooling of the components of a switchgear shall be improved.

The object of the invention is solved by a switchgear as defined in the opening paragraph, additionally comprising a disconnector housing, which is arranged within the switchgear housing and encompasses at least the disconnectors, wherein the disconnector housing has at least one bottom opening and at least one top opening allowing an air flow from the at least one bottom opening to the at least one top opening via said disconnectors.

By these measures, an air flow via the disconnectors (in particular based on thermal convection) can be improved because it is focused to the disconnectors, wherein at the same time, insulation requirements can be fulfilled. The openings in the disconnector housing provide improved cooling of the disconnectors and other optional parts enclosed by the disconnector housing. In particular, the disconnector housing can be made from plastic. In this way, a good electric insulation of the disconnectors and other parts enclosed by the disconnector housing can be provided. Nevertheless, the disconnector housing could also be made from a different material, e.g. from metal. If the disconnector housing is made from metal, beneficially it can be grounded.

Advantageously, the switchgear housing can provide an insulation of IP68 according to ISO 20653 what means that the switchgear housing is dust-tight and water-tight up to a depth of at least 1 meter. In this way, the switchgear may be exposed to unfavorable environmental conditions like high humidity and heavy rain without problems. Although, no external air flow is possible in this case, cooling of the disconnectors and other optional parts enclosed by the disconnector housing is ensured by the disconnector housing and the proposed measures.

Further advantageous embodiments are disclosed in the claims and in the description as well as in the figures.

Beneficially, the disconnector housing can have a first bottom opening and a second bottom opening facing downwards, a first top opening and a second top opening facing upwards and a third top opening facing downwards. In this way, a vertical air flow or an air flow at least having a vertical component and thus thermal convection is enabled. By use of the third top opening, the air flow can be directed round about parts in the switchgear which are arranged above the disconnector housing.

Generally, the disconnector housing can have a height, which is its vertical extension, a length, which is its horizontal extension in a direction parallel to a longitudinal extension of a blade of the disconnector, and a width, which is its horizontal extension in a direction perpendicular to the longitudinal extension of the blade of the disconnector. Advantageously,
a total width of the first bottom opening and the second bottom opening is in a range of 0.85 to 0.95 times the width of the disconnector housing and/or
a total length of the first bottom opening and the second bottom opening is in a range of 0.4 to 0.6 times the length of the disconnector housing and/or
a total width of the first top opening and the second top opening is in a range of 0.85 to 0.95 times the width of the disconnector housing and/or
a total length of the first top opening and the second top opening is in a range of 0.4 to 0.6 times the length of the disconnector housing and/or
a total length of the third top opening is in a range of 0.05 to 0.15 times the length of the disconnector housing.

In this way, comparably strong air flows based on thermal convection can be achieved.

Beneficially, the third top opening can face downwards and can be arranged at distance of 0.15 to 0.25 times the height of the disconnector housing measured from the top of the disconnector housing. In this way, the air flow can be directed round about parts in the switchgear which are arranged above the disconnector housing without reducing the air flow very much.

In a very advantageous embodiment of the switchgear, a ratio between a total area of the top openings and a total area of the bottom openings is in a range of 0.5 to 0.7. In this way, a strong chimney effect can be achieved.

In another very advantageous embodiment of the switchgear, at least one side wall of the disconnector housing is inclined at an angle of at least 5° measured against a vertical line. In this way, a strong chimney effect can be achieved as well.

Further on it is of advantage if
the busbars have first busbar sections being arranged on top of another and running parallel to each other in their longitudinal extension and
second busbar sections being arranged horizontally next to each other and running parallel to each other in their longitudinal extension, wherein
the longitudinal extension of the first busbar sections is oriented perpendicular to the longitudinal extension of the second busbar sections and wherein
a first busbar section is connected to a second busbar section each one after another beginning at the end of the first busbar section of the lowest busbar.

In this way, first busbar sections of the different busbars exposed to an airflow have different length. The busbar with the longest first busbar section is arranged at the bottom and the busbar with the shortest first busbar section is arranged at the top. Accordingly, the busbar with the longest first busbar section is exposed to cooler air than the busbar with the shortest first busbar section because of the vertical air flow, and an overall temperature reduction of the busbar arrangement can be achieved.

In the above context, it is also of advantage if
the first busbar sections are arranged out of the disconnector housing and
the second busbar sections pass a wall of the disconnector housing and are connected to the first busbar sections and the disconnectors each, wherein
the disconnectors are arranged horizontally next to each other and run parallel to each other in their longitudinal extension.

Moreover, it is advantageous in the above context if
vacuum interrupters are arranged in the disconnector housing and are connected to the disconnectors each, wherein
the vacuum interrupters are arranged vertically next to each other and run parallel to each other in their longitudinal extension and wherein
third busbar sections are connected to the vacuum interrupters each.

Advantageously, the disconnector housing has at least one third bottom opening arranged in the region of the vacuum interrupter. In this way, cooling of parts inside the disconnector housing can further be improved.

Beneficially, the switchgear comprises an outer disconnector housing enclosing a plurality of disconnector housings (and other components as the case may be). In this way electrical insulation against other parts of the switchgear out of the outer disconnector housing can be improved.

In particular, the outer disconnector housing can made from metal. In this way, electrical insulation against other parts of the switchgear out of the outer disconnector housing can be further improved, in particular if the outer disconnector housing is grounded.

Further on, the outer disconnector housing can provide an insulation of IP67 according to ISO 20653 what means that the outer disconnector housing is dust-tight and water-tight up to a depth of 1 meter.

### BRIEF DESCRIPTION OF DRAWINGS

The invention now is described in more detail hereinafter with reference to particular embodiments, which the invention however is not limited to.

FIG. 1 shows an exemplary switchgear in oblique view;

FIG. 2 show a more detailed view of the arrangement comprising the disconnector housings;

FIG. 3 like FIG. 2 but with the front disconnector housing removed;

FIG. 4 shows a cross section through the disconnector housing;

FIG. 5 shows the busbars, the disconnectors and the vacuum interrupters in isolated view;

FIG. 6 shows an oblique view of the disconnector housing from above;

FIG. 7 shows an oblique view of the disconnector housing from below;

FIG. 8 shows a top view of the disconnector housing;

FIG. 9 shows a bottom view of the disconnector housing and

FIG. 10 shows a back view of the disconnector housing.

### DETAILED DESCRIPTION

Generally, same parts or similar parts are denoted with the same/similar names and reference signs. The features disclosed in the description apply to parts with the same/similar names respectively reference signs. Indicating the orientation and relative position is related to the associated figure, and indication of the orientation and/or relative position has to be amended in different figures accordingly as the case may be.

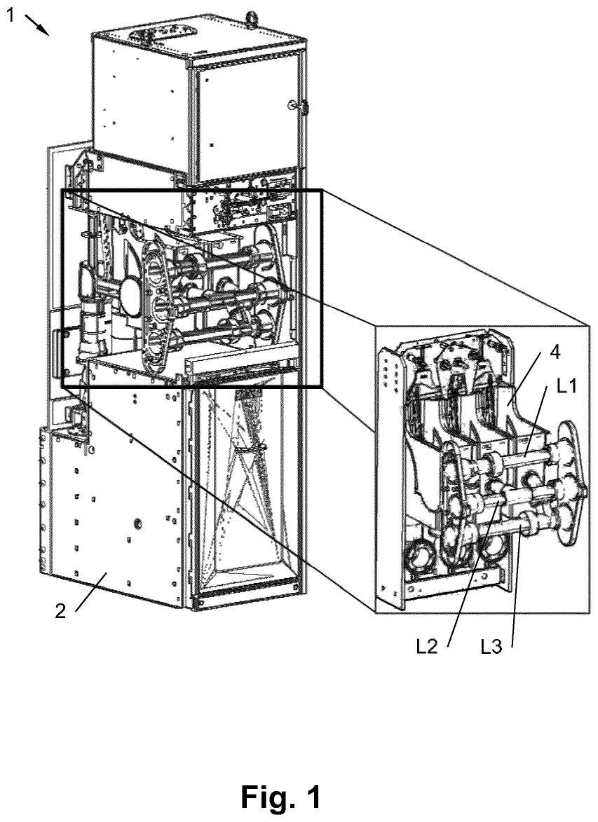

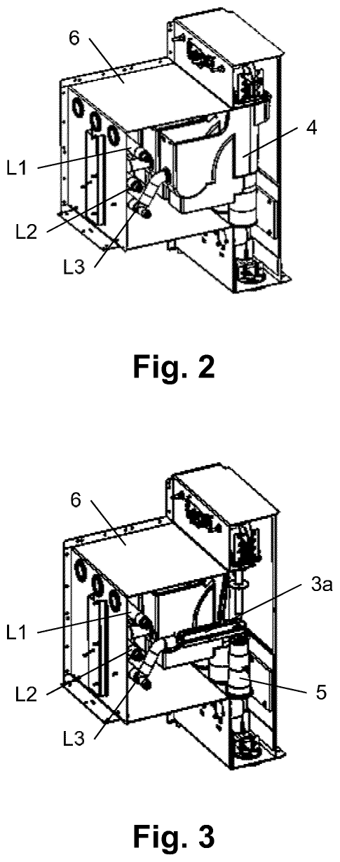

FIG. 1 shows an exemplary switchgear 1 with a switchgear housing 2, a number of busbars L1 . . . L3 within the switchgear housing 2 and a number of disconnector housings 4, which are arranged within the switchgear housing 2, too. The disconnector housings 4 each encompass a disconnector 3a . . . 3c being arranged in the course of the busbars L1 . . . L3 (see FIGS. 2 to 5 in this context). In the left region of FIG. 1, there is shown the whole switchgear 1, in the right region there is shown a cut out of the switchgear 1, namely a detailed view of the disconnector housings 4 and the busbars L1 . . . L3.

In particular, the switchgear housing 2 can provide an insulation of IP68 according to ISO 20653 what means that the switchgear housing 2 is dust-tight and water-tight up to a depth of at least 1 meter. In this way, the switchgear 1 may be exposed to unfavorable environmental conditions like high humidity and heavy rain without problems. However, this does also mean that no external air flow is possible in this case.

FIGS. 2 and 3 show a more detailed view of the arrangement comprising the disconnector housings 4. In addition to the busbars L1 . . . L3 and the disconnector housings 4, FIG. 2 shows vacuum interrupters 5 in the current paths and an outer disconnector housing 6 enclosing a plurality of disconnector housings 4 (and a part of the busbars L1 . . . L3). In FIG. 2, the side wall of the outer disconnector housing 6 is removed to allow a view into the interior of the outer disconnector housing 6. In FIG. 3, in addition one of the disconnector housings 4 is removed to allow a view into the interior of the disconnector housing 4. In detail, a disconnector 3a of the disconnectors 3a . . . 3c is visible.

In particular, the outer disconnector housing 6 can provide an insulation of IP67 according to ISO 20653 what means that the outer disconnector housing 6 is dust-tight and water-tight up to a depth of 1 meter.

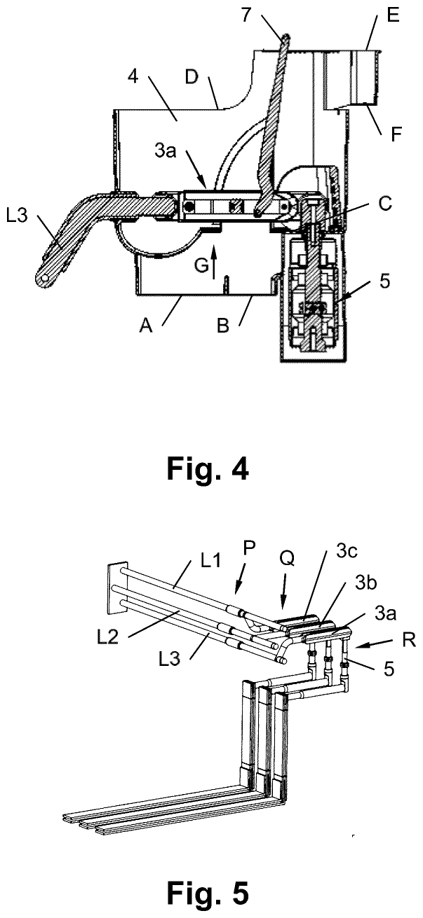

FIG. 4 shows a cross section through the disconnector housing 4 and hence a more detailed view of the disconnector 3a, the disconnector housing 4, the vacuum interrupter 5 and the busbar L3. In detail, FIG. 4 also shows a lever 7 for actuating the disconnector 3a.

Moreover, FIG. 4 shows that the disconnector housing 4 in this embodiment has a first bottom opening A and a second bottom B opening facing downwards, an optional third bottom opening C arranged in the region of the vacuum interrupter 5, a first top opening D and a second top opening E facing upwards and a third top opening F facing downwards. The bottom openings A . . . C and the top openings D . . . F allow an air flow G from the bottom openings A . . . C to the top openings D . . . F via the disconnector 3a.

FIG. 5 shows the busbars L1 . . . L3, the disconnectors 3a . . . 3c and the vacuum interrupters 5 in isolated view. In this embodiment, the busbars L1 . . . L3 comprise optional first busbar sections P being arranged on top of another and running parallel to each other in their longitudinal extension and optional second busbar sections Q being arranged horizontally next to each other and running parallel to each other in their longitudinal extension. The longitudinal extension of the first busbar sections P is oriented perpendicular to the longitudinal extension of the second busbar sections Q. Moreover, a first busbar section P is connected to a second busbar section R each one after another beginning at the downstream end of the first busbar section P of the lowest busbar. That means, a connection of the first busbar section P and the second busbar section R of the busbar L3 is the lowest one and the connection of the first busbar section P and the second busbar section R of the busbar L1 is the highest one. In this way, the busbar L1 with the longest first busbar section P is exposed to cooler air than the busbar L3 with the shortest first busbar section P because of the vertical air flow, and an overall temperature reduction of the busbar arrangement can be achieved.

Moreover, the first busbar sections P are arranged out of the disconnector housing 4 and the second busbar sections Q pass a wall of the disconnector housing 4 and are connected to the first busbar sections P and the disconnectors 3a . . . 3c each in this embodiment. The disconnectors 3a . . . 3c are arranged horizontally next to each other and run parallel to each other in their longitudinal extension.

Further on, the vacuum interrupters 5 are arranged in the disconnector housing 4 and are connected to the disconnectors 3a . . . 3c each in this embodiment. The vacuum interrupters 5 are arranged vertically next to each other and run parallel to each other in their longitudinal extension, wherein third busbar sections R are connected to the vacuum interrupters 5 each.

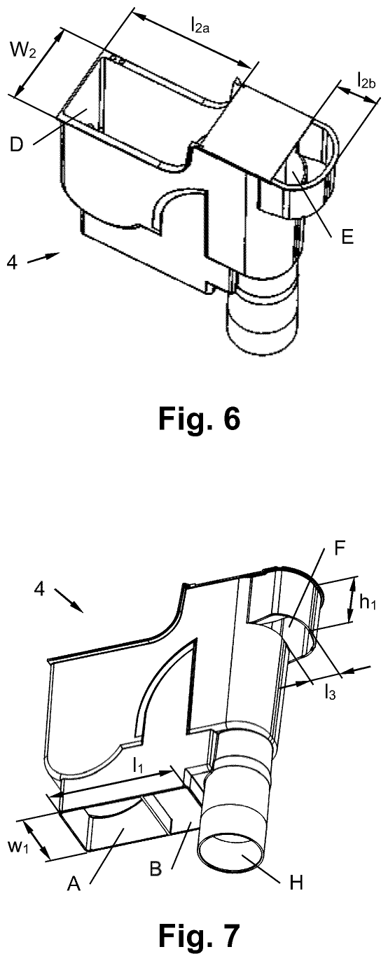

FIGS. 6 and 7 now show oblique views of the disconnector housings 4, FIG. 6 from above and FIG. 7 from below. In detail, the openings A, B, D, E, F and a bus bar opening H are visible.

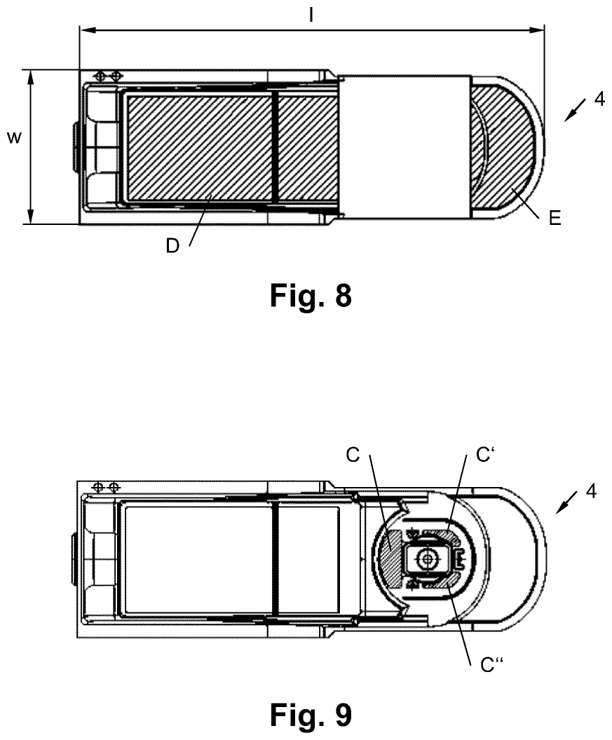

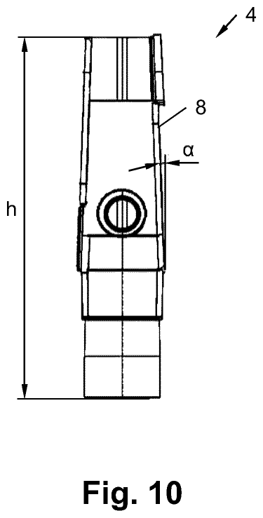

Generally, the disconnector housing 4 has a height h, which is its vertical extension, a length l, which is its horizontal extension in a direction parallel to a longitudinal extension of a blade of the disconnector 3a . . . 3c, and a width w, which is its horizontal extension in a direction perpendicular to the longitudinal extension of the blade of the disconnector 3a . . . 3c (see FIGS. 8 and 10 indicating the outer dimensions of the disconnector housing 4.

In a preferred embodiment,
a total width w₁ of the first bottom opening A and the second bottom opening B is in a range of 0.85 to 0.95 times the width w of the disconnector housing 4 and/or
a total length l₁ of the first bottom opening A and the second bottom opening B is in a range of 0.4 to 0.6 times the length l of the disconnector housing 4 and/or
a total width w₂ of the first top opening D and the second top opening E is in a range of 0.85 to 0.95 times the width w of the disconnector housing 4 and/or
a total length I₂ₐ+l_{2b} of the first top opening D and the second top opening E is in a range of 0.4 to 0.6 times the length of the disconnector housing 4 and/or
a total length l₃ of the third top opening F is in a range of 0.05 to 0.15 times the length l of the disconnector housing 4.

Moreover, it is of advantage if the third top F opening faces downwards and is arranged at distance h₁ of 0.15 to 0.25 times the height h of the disconnector housing 4 measured from the top of the disconnector housing 4 as this is the case in this embodiment.

FIG. 8 shows a top view of the disconnector housing 4 with the first top opening D and the second top opening E hatched indicating their areas. FIG. 9 shows a bottom view of the disconnector housing 4 with the third bottom openings C . . . C″ in the region of the vacuum interrupter 5 being hatched indicating their areas. In a preferred embodiment, a ratio between a total area of the top openings D . . . F and a total area of the bottom openings A . . . C″ is in a range of 0.5 to 0.7. In this way, a strong chimney effect can be achieved.

Finally, FIG. 10 shows a back view of the disconnector housing 4. In this embodiment the side walls 8 of the disconnector housing 4 are inclined at an angle α of at least 5° measured against a vertical line. In this way, a strong chimney effect can be achieved as well.

In a beneficial embodiment, the disconnector housing 4 is made from plastic. In this way, good electric insulation of the disconnectors 3a . . . 3c (and other parts enclosed by the disconnector housing 4) can be ensured.

Beneficially, the outer disconnector housing 6 can be made from metal. In this way, electrical insulation against other parts of the switchgear 2 out of the outer disconnector housing 6 can be further improved, in particular if the outer disconnector housing 6 is grounded.

It is noted that the invention is not limited to the embodiments disclosed hereinbefore, but combinations of the different variants are possible. In reality, the switchgear 1 may have more or less parts than shown in the figures. Moreover, the description may comprise subject matter of further independent inventions.

It should also be noted that the term “comprising” does not exclude other elements and the use of articles “a” or “an” does not exclude a plurality. Also elements described in association with different embodiments may be combined. It should also be noted that reference signs in the claims should not be construed as limiting the scope of the claims.

### LIST OF REFERENCE NUMERALS

1 switchgear
2 switchgear housing
3a . . . 3c disconnector
4 disconnector housing
5 vacuum interrupter
6 outer disconnector housing
7 lever
8 side wall
A . . . C bottom opening
D . . . F″ top opening
G air flow
H bus bar opening
L1 . . . L3 busbar
P . . . R busbar section
α angle of side wall
h height of disconnector housing
l length of disconnector housing
l₁ total length of first and second bottom opening
l₂ₐ length of first top opening
l_{2b} length of second top opening
l₃ total length of third top opening
W width of disconnector housing
w₁ total width of first and second bottom opening
w₂ total width of first and second top opening

1. Switchgear, comprising
a switchgear housing a switchgear housing that is dust-tight and water-tight when submerged up to a depth of at least 1 meter,
a number of busbars within the switchgear housing,
a number of disconnectors within the switchgear housing, which are arranged in the course of the busbars,
wherein
a disconnector housing, which is arranged within the switchgear
housing and encompasses at least the disconnectors, wherein the disconnector housing has at least one bottom opening and at least one top opening allowing an air flow from the at least one bottom
opening to the at least one top opening via said disconnectors.

2. Switchgear as claimed in claim 1, wherein the disconnector housing has a first bottom opening and a second bottom opening facing downwards, a first top opening and a second top opening facing upwards and a third top opening facing downwards.

3. Switchgear as claimed in claim 2, wherein the disconnector housing has a height, which is its vertical extension, a length, which is its horizontal extension in a direction parallel to a longitudinal extension of a blade of the disconnector, and a width, which is its horizontal extension in a direction perpendicular to the longitudinal extension of the blade of the disconnector, wherein
a total width of the first bottom opening and the second bottom opening is in a range of 0.85 to 0.95 times the width of the disconnector housing and/or a total length of the first bottom opening and the second bottom opening is in a range of 0.4 to 0.6 times the length of the disconnector housing and/or
a total width of the first top opening and the second top opening is in a range of 0.85 to 0.95 times the width of the disconnector housing and/or
a length of the first top opening plus a length of the second top opening is in a range of 0.4 to 0.6 times the length of the disconnector housing and/or
a total length of the third top opening is in a range of 0.05 to 0.15 times the length of the disconnector housing.

4. Switchgear as claimed in claim 3, wherein the third top opening faces downwards and is arranged at distance of 0.15 to 0.25 times the height of the disconnector housing measured from the top of the disconnector housing.

5. Switchgear as claimed in claim 1, wherein a ratio between a total area of the top openings and a total area of the bottom openings is in a range of 0.5 to 0.7.

6. Switchgear as claimed in claim 1 wherein at least one side wall of the disconnector housing is inclined at an angle of at least 5° measured against a vertical line.

7. Switchgear as claimed in claim 1, wherein the busbars have first busbar sections being arranged on top of another and running parallel to each other in their longitudinal extension and
second busbar sections being arranged horizontally next to each other and running parallel to each other in their longitudinal extension, wherein
the longitudinal extension of the first busbar sections is oriented perpendicular to the longitudinal extension of the second busbar sections and wherein
a first busbar section is connected to a second busbar section each one after another beginning at an end of the first busbar section of the lowest busbar.
